(19) United States
(12) Patent Application Publication
(10) Pub. No.: US 2006/0194540 A1
(43) Pub. Date: Aug. 31, 2006

(54) Self organizing multi-channel management

(75) Inventors: Jason F. Hunzinger, Escondido, CA (US); John M. Belstner, Valley Center, CA (US)

Correspondence Address: HARNESS, DICKEY & PIERCE, P.L.C., P.O. BOX 828, BLOOMFIELD HILLS, MI, 48303, US

(73) Assignee: DENSO Corporation, Kariya-city (JP)

(21) Appl. No.: 11/291,135

(22) Filed: Nov. 30, 2005

Related U.S. Application Data
(60) Provisional application No. 60/657,223, filed on Feb. 28, 2005.

(51) Int. Cl. H04B 7/00

(52) U.S. Cl. 455/41.2

(57) ABSTRACT

A wireless station and associated method is provided for communicating digital messages. A first transceiver tunes to a first radio frequency. A digital controller enables the first transceiver to transmit on the first radio frequency during intermittent periods of varying durations. The intermittent periods are separated by a fixed duration.

### CROSS-REFERENCE TO RELATED APPLICATIONS

This application claims the benefit of U.S. Provisional Application No. 60/657,223, filed on Feb. 28, 2005. The disclosure of the above application is incorporated herein by reference.

### FIELD

The present disclosure relates to wireless networking.

### BACKGROUND

The statements in this section merely provide background information related to the present disclosure and may not constitute prior art.

Vehicle sensors such as radar can provide a vehicle with short-range line-of-sight detection of obstacles. However it is desirable in some situations to detect obstacles that are more distant and/or non-line of sight. Furthermore, information about what may happen in the near future, such as vehicle motion, and status information, such as traffic light phase, is preferably communicated among vehicles and related infrastructure. Communication of such safety related information among vehicles provides opportunities for early detection of the obstacles and other situations that may either be undetected by sensors or otherwise detected too late to take action. Latency is therefore a concern for communication of vehicle safety-related data since the data may be used by other vehicles to make control decisions or provide real-time traffic information to vehicle operators. In addition to safety-related data, communication of non-safety information among vehicles offers the possibility of other applications such as electronic toll collection, entertainment, and computing.

One known communication system simultaneously uses a plurality of radio channels to provide ample bandwidth for communicating the safety and the non-safety messages. The system includes a mechanism to subdivide communications according to the information, purpose and/or units involved, for example. However such a system is generally not compatible with a vehicle or roadside unit that has only one transceiver and that can receive or transmit on only one channel at a time. Wireless on-board units (also referred to by terms such as wireless stations, vehicle radios, vehicle units, mobile stations, wireless network interfaces, and/or subscribers, etc.) having a plurality of transceivers may simultaneously access the plurality of channels and thereby provide a minimal delay time to access channel(s) that carry the safety information. However, such multi-radio wireless units are undesirably expensive, particularly for in-vehicle systems. Furthermore, since it is costly to deploy road side units (also referred to by terms such as access points, fixed units, wireless network interfaces, and/or providers, etc) that cover extensive geographic areas, a system that can create an ad-hoc network between vehicles is also desirable.

Dedicated Short Range Communication (DSRC) standards (IEEE P802.11p, P1609.1-4 standard drafts and ASTM standard E-2213-3) are being developed for such vehicle communications and are based on IEEE 802.11a/b/g standards. Other standards related to power control, channel selection for interference reduction, and quality of service are being derived from IEEE 802.11h and 802.11e standards. The aforementioned standards are hereby incorporated by reference in their entirety.

As an alternative to using the plurality of radio channels, an inexpensive wireless network interface operating on a single radio channel may be used instead. However, known methods of selecting one of the pluralities of channels also have undesirable aspects. For example, a method of synchronizing channel switching among transceivers produces an undesirable timekeeping burden between wireless stations. A second method provides for carrying copies of given messages on more than one of the plurality of channels which results in an undesirably inefficient use of the bandwidth. A third method provides for fixing periods of control channel monitoring and service channel operation. However, this third method also imposes undesirable timekeeping burdens as well as inflexibility to changing volumes of messages. This third method may therefore be considered to have an inefficient use of bandwidth as well.

### SUMMARY

A wireless station for communicating digital messages is provided. The wireless station includes a first transceiver tuned to a first radio frequency. A digital controller enables the first transceiver to transmit on the first radio frequency during intermittent periods of varying durations that are separated by a fixed duration.

A method for communicating digital messages over a wireless medium is provided. The method includes tuning to a first radio frequency and transmitting on the first radio frequency during intermittent periods of varying durations that are separated by a fixed duration.

A wireless station for communicating digital messages is provided. The wireless station includes first transceiver means for communicating over a first radio frequency. The wireless station also includes digital controller means for enabling the first transceiver means to transmit on the first radio frequency during intermittent periods of varying durations that are separated by a fixed duration.

Further areas of applicability will become apparent from the description provided herein. It should be understood that the description and specific examples are intended for purposes of illustration only and are not intended to limit the scope of the present disclosure.

### DRAWINGS

The drawings described herein are for illustration purposes only and are not intended to limit the scope of the present disclosure in any way.

FIG. 1 is a block diagram of Self-Organizing Multi-Channel Management (SMM) components;

FIG. 2 is a timing diagram of an SMM cycle;

FIG. 3 is a timing diagram of an Independent Reference Channel (IRC) period;

FIG. 4 is a timing diagram of an adaptive IRC period;

FIG. 5 is a block diagram of IRC prioritization;

FIG. 6 is a timing diagram of Low Priority (LP) IRC messages being received during a IRC period;

FIG. 7 is a timing diagram of LP IRC messages being received while remaining tuned to the IRC during a Non-Reference Channel (NRC) period;

FIG. 8 is a timing diagram of wireless communications as a wireless station acquires an existing network;

FIG. 9 is a timing diagram of wireless communications as a network is formed;

FIG. 10 is a timing diagram of wireless communications during a High-Awareness mode;

FIG. 11 is a timing diagram of wireless communications during an IRC point coordination mode;

FIG. 12 is a state diagram of IRC system states;

FIG. 13 is a state diagram of initialization states;

FIG. 14 is a state diagram of normal operation states; and

FIG. 15 is a state diagram of CME states.

### DETAILED DESCRIPTION

The following description is merely exemplary in nature and is not intended to limit the present disclosure, application, or uses. It should be understood that throughout the drawings, corresponding reference numerals indicate like or corresponding parts and features.

The present disclosure describes channel switching operations that enable single-channel, half-duplex wireless stations to network with like wireless stations in a multi-channel band. Multi-radio and full-duplex stations are also supported. The disclosed methods may be used with wireless devices that are otherwise compliant with the Institute of Electrical and Electronics Engineers (IEEE) 802.11-based Medium Access Control (MAC) and Physical Layer (PHY) standards and IEEE 802.11e-based quality of service (QoS) standard. The IEEE 802.11-1999 and IEEE 802.11e specifications are hereby included by reference in their entirety.

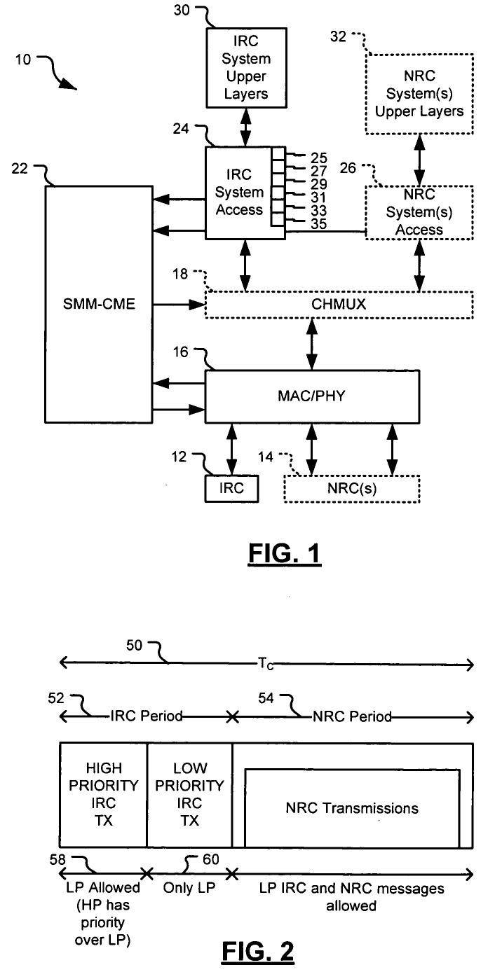

Referring now to FIG. 1, one of various embodiments is shown of a wireless station 10. Wireless station 10 can be included in a base station and in a subscriber station. Base stations include, without limitation, access points, fixed stations, and road-side units. Subscriber stations include, without limitation, mobile stations, mobile subscriber stations, and on-board units. The architecture of wireless station 10 is transparent to various networking modes including, without limitation, hierarchical, mesh, ad hoc, multi-hop, and other networking options and combinations thereof.

Wireless station 10 includes a first radio frequency (RF) transceiver 12 that is tuned to a predetermined independent reference channel (IRC). When wireless station 10 is implemented in a multi-radio and/or full-duplex station, then wireless station 10 can also include a second RF transceiver 14. Second wireless transceiver 14 tunes to at least one non-reference channel (NRC).

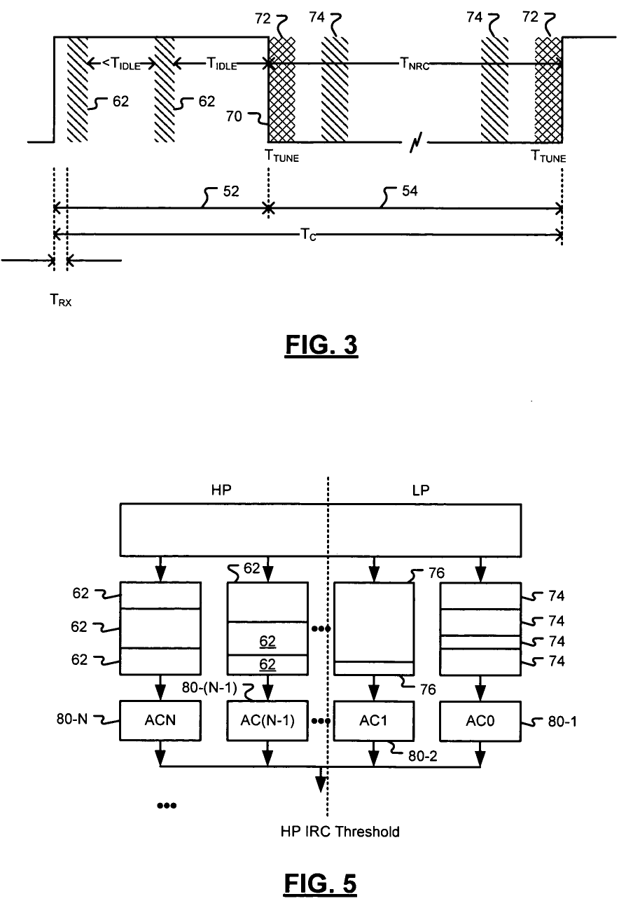

In a preferred embodiment, the IRC is dedicated to primary vehicle safety communications while the NRC(s) are used for other purposes such as non-safety communications. High-priority safety messages communicated on the IRC are HP IRC messages 62 (FIG. 3).

First and second RF transceivers 12, 14 communicate with a medium access controller and physical layer (MAC/PHY) 16. MAC/PHY 16 communicates digital data with a channel multiplexer (CHMUX) 18. An SMM channel management entity (SMM-CME) 22 communicates with MAC/PHY 16 and determines which of the first and second RF transceivers 12, 14 communicates with MAC/PHY 16. In some embodiments MAC/PHY 16 maintains a separate MAC state for each of the channels. MAC/PHY 16 includes a computer with associated memory for maintaining the MAC states and variables used in the methods described below, including IEEE 802.11e variables. MAC/PHY 16 maintains a MAC state for channel that wireless station 10 tunes to and suspends the respective MAC state when tuning away from an associated channel. MAC/PHY 16 then recovers the MAC state when wireless station 10 tunes back to the associated channel.

CHMUX 18 routes the digital data to one of an IRC system access module 24 and an NRC system(s) access module 26. IRC system access module 24 communicates with IRC system upper layers 30, which can include one or more computer applications. IRC system access module 24 includes an IRC idle timer 25, search timer 27, reacquisition timer 29, network creation timer 31, high awareness (HA) timer 33, and NRC timer 35 that are used by the methods described below. Services offered by IRC system upper layers 30 generally require high priority, low latency, and high availability access to the IRC. In some embodiments, IRC system upper layers 30 include safety related applications, such as occupant protection and/or anti-lock brake controls in a vehicle.

NRC system(s) access module 26 communicates with NRC systems(s) upper layers 32, which can include computer applications. In some embodiments NRC systems(s) upper layers 32 include computing related applications, such as e-mail, gaming, file transfer, web browsing, streaming entertainment, etc. CHMUX 18 routes the digital data to one of IRC system access module 24 and NRC systems(s) access module 26 in accordance with a channel select signal from SMM-CME 22.

NRC systems(s) access module 26, and NRC systems(s) upper layers 32, and CHMUX 18 can be omitted in single-radio wireless stations 10. In such an arrangement MAC/PHY 16 communicates the digital data directly with IRC system access module 24.

SMM-CME 22 includes a computer that executes Self-Organizing Multi-Channel Management (SMM) methods, which are stored in an associated computer memory. The methods are described below and coordinate channel switching among a network of wireless stations 10. The channel switching is based on a timing of high-priority (HP) messages 62 (FIG. 3) transmitted and received on the IRC. The methods track a distributed system time reference inherent in HP IRC messages 62. The methods allow single-radio half-duplex wireless stations 10 to network with other wireless stations 10 over the IRC. The methods also allow multi-radio and/or full-duplex wireless stations 10 to enjoy the benefits of the bandwidth available over the NRC(s). Synchronized channel switching among wireless stations 10 is generally a distributed function using the methods provided herein; however a point coordination function is also provided.

Referring now FIG. 2, a timing diagram is shown of an SMM cycle 50. SMM cycle 50 includes an IRC period 52 and an NRC period 54. The duration of IRC period 52 varies according to the SMM methods as is described below. The duration of NRC period 54 is set to a predetermined period T_{NRC}. T_{NRC} is equal for all wireless stations 10. T_{NRC} should be set such the channel latency is less than a desired period. The channel latency is the time between when a wireless station 10 has a packet ready for transmission on a channel and when another wireless station is tuned to that channel. In some embodiments the NRC period 54 is equal to 50 milliseconds (mS). Channel switching restrictions are applied based on time periods within each IRC period 52 and NRC period 54.

Wireless station 10 is tuned to the IRC during IRC period 52. During NRC period 54, wireless station 10 may remain tuned to the IRC or tune to the NRC(s). Channel switching among the NRC(s) is coordinated according to other methods known in the art, such as methods provided by the IEEE 802.11 and/or IEEE 802.11e specifications, and are not explained further in this disclosure.

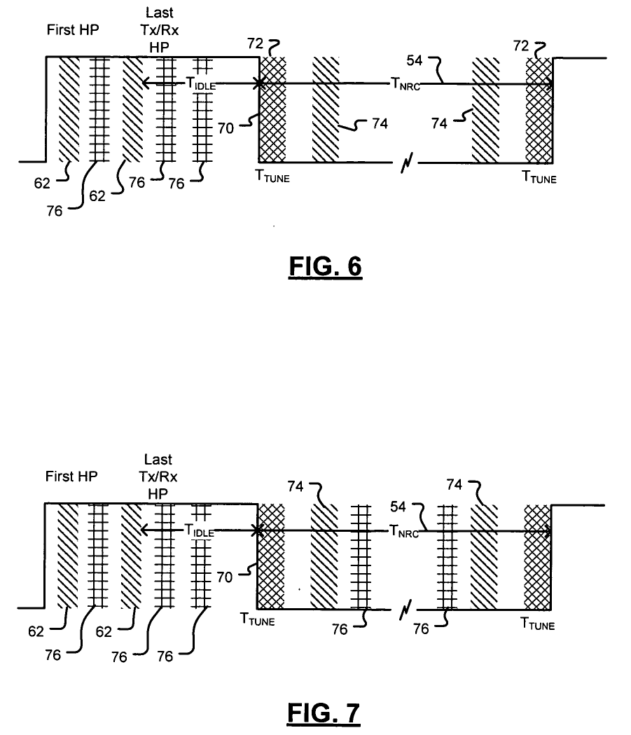

IRC period 52 can include a first sub-period 58 during which HP IRC messages and/or Low-Priority (LP) IRC messages 76 (FIG. 6) can be exchanged between wireless stations 10. IRC period 52 can also include a second sub-period 60 during which LP IRC messages 76 are communicated between wireless stations 10. The duration of IRC period 52 varies to accommodate all necessary pending HP IRC messages 62. In some embodiments, the HP IRC messages 62 are broadcast throughout a network of wireless stations 10. The LP IRC messages 76 and NRC messages 74 (FIG. 6) can be exchanged during NRC period 54.

Referring now to FIG. 3, a detailed timing diagram is shown of IRC period 52. IRC period 52 begins with a period T_{RX} that compensates for timing differences between wireless stations 10. In some embodiments T_{RX} is equal to 1 mS. Wireless station 10 does not transmit HP IRC messages 62 during the period T_{RX}. Wireless station 10 may, however, receive HP IRC messages 62 during the period T_{RX}. Wireless station 10 may begin transmitting its HP IRC messages 62 upon expiration of the period T_{RX}. In some embodiments, wireless station 10 employs a collision avoidance protocol, such as 802.11 CSMA/CA and/or a small random component to the T_{RX} value, that pseudo-randomly determines when to begin transmitting any message. The collision avoidance protocol reduces the probability that a plurality of wireless stations 10 will transmit simultaneously on any one of the IRC and NRC(s).

IRC idle timer 25 starts at the end of the period T_{RX} and restarts at the end of each HP IRC message 62. IRC idle timer 25 resets each time wireless station 10 sends or receives another HP IRC message 62. IRC period 52 endures until IRC idle timer 25 runs uninterrupted for a predetermined time T_{IDLE}. The duration of IRC period 52 thereby adapts to accommodate all pending HP IRC messages 62. In some embodiments T_{IDLE} is equal to 5 mS. The value of T_{IDLE} should be set to accommodate the maximum possible packet duration of a packet transmitted on the IRC. Wireless station 10 may also transmit LP IRC messages during IRC period 52, however the LP IRC messages do not cause IRC idle timer 25 to be reset.

Wireless stations 10 that are in range of one another each reset their respective IRC idle timers 25 upon receiving last HP IRC message 62. Since the T_{IDLE} of each wireless station 10 is equal, the wireless stations 10 that are in range of one another tune to NRC at the same time. Furthermore, since the NRC period 54 is fixed in duration, those wireless stations 10 tune back to the IRC at the same time.

IRC period 52 ends and NRC period 54 begins when IRC idle timer 25 expires at time 70. Tuning periods 72 at the beginning and end of NRC period 54 have duration T_{TUNE} and define a Maximum Channel Switching Delay for wireless station 10 to tune out of and into the IRC. In some embodiments T_{TUNE} is equal to 2 mS. IRC system access module 24 indicates when wireless station 10 must tune to the IRC and when wireless station 10 can tune away from the IRC, e.g., to the NRC(s). Tuning commands from IRC system access module 24 to SMM-CME 22 should occur with ample lead time so that wireless station 10 is tuned to the IRC for the entire IRC period 52. NRC system(s) access module 26 provides RF tuning commands to SMM-CME 22 during NRC period 54.

NRC messages 74 are transmitted and received during NRC period 54 on the NRC. IRC and NRC periods 52, 54 together occupy a cycle time T_{C} that varies due to the adaptive nature of IRC period 52.

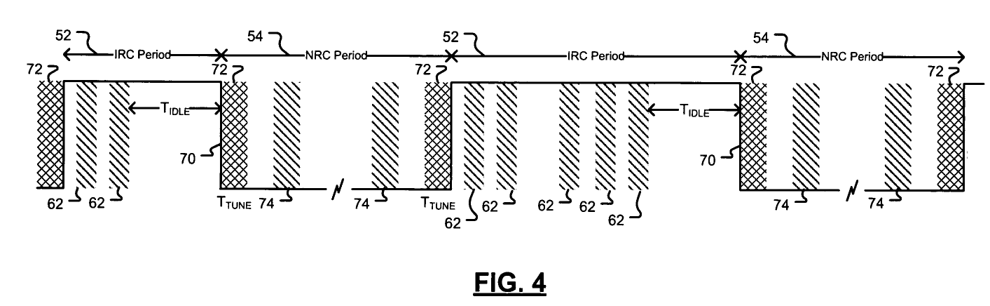

Referring now to FIG. 4, a timing diagram of IRC periods 52 are shown of varying duration with intervening NRC periods 54 having a fixed duration. IRC periods 52 are determined by a number of HP IRC messages 62 that are transmitted within T_{IDLE} of each other. Each IRC period 52 ends when IRC idle timer 25 expires.

Referring now to FIG. 5, a block diagram is shown of access categories (AC) for the HP IRC messages 62, LP IRC messages 76, and NRC messages 74. IRC system upper layer 30 and NRC system upper layers(s) 32 generate and queue respective messages according to a predetermined priority. In some embodiments the priorities are determined according to an access category (AC) method described in the IEEE 802.11e specification.

A plurality of queues 80-1, . . . , 80-N, hold the respective messages of predetermined priorities. The highest priority messages, which are to the left of dotted line 82, are HP IRC messages 62. Messages to the right of dotted line 82 are LP IRC messages 76 and/or NRC messages 74. HP IRC messages 62 are transmitted during each IRC period 52, thereby leaving their respective queues 80 empty. All of the LP IRC messages 76 can also be transmitted during IRC period 52. If LP IRC messages 76 are transmitted during NRC period 50 there is a possibility that they will not all be transmitted during a single NRC period 54.

Referring now to FIG. 6, a timing diagram is shown of LP messages 76 being received by a wireless station 10 that tunes out of the IRC during NRC period 54. Wireless station 10 is tuned to the IRC during IRC period 52 and therefore receives LP IRC messages 76 that are sent by other wireless stations 10. During the NRC period 54 the wireless station 10 tunes away from the IRC and therefore stops receiving LP IRC messages 76. Care should therefore be taken when transmitting LP IRC messages 76 during NRC period 54 as some wireless stations 10 may miss some or all of LP IRC messages 76. NRC system(s) access module 26 should not request channel changes away from the IRC unless and until reasonably necessary for NRC system(s) upper layers 32 and/or reasonably acceptable to performance on the IRC. Also, NRC system(s) access module 26 should request that SME-CME 22 tune back to the IRC when communications over the NRC(s) are complete.

Referring now to FIG. 7, a timing diagram is shown of LP IRC messages 76 that are received by a wireless station 10 that remains tuned to the IRC during NRC period 54. Wireless station 10 receives all LP IRC messages 76 that are sent by other wireless stations 10.

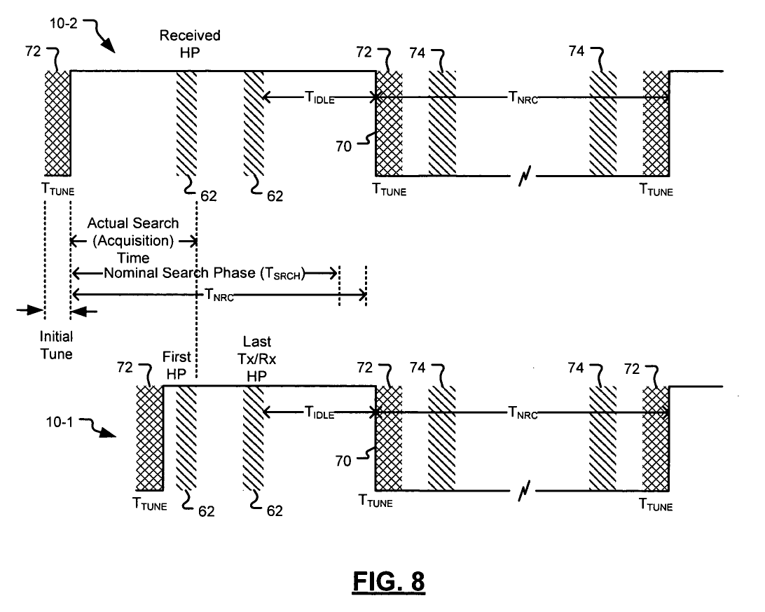

Referring now to FIG. 8, a timing diagram is shown as a first wireless station 10-1 joins a network that includes a second wireless station 10-2. First wireless station 10-1 listens for HP IRC messages 62 that are transmitted by second wireless station 10-2. First wireless station 10-1 resets its IRC idle timer each time it receives an HP IRC message 62. Once IRC idle timer 25 reaches T_{IDLE}, first wireless station 10-1 adopts the timing of second wireless station 10-2 and the two wireless stations 10-1, 10-2 may begin communicating as a network.

First wireless station 10-1 must not transmit on the IRC while attempting to join the network. In the event first wireless station 10-1 is attempting to join the network and does not receive an HP IRC message 62 for a predetermined time T_{SRCH}, then wireless station 10-1 may transmit at least one HP IRC message 62 to attempt to initiate a network with another wireless station 10. Search timer 27 tracks T_{SRCH}. The time T_{SRCH} is equal to NRC period 54 less T_{TUNE}.

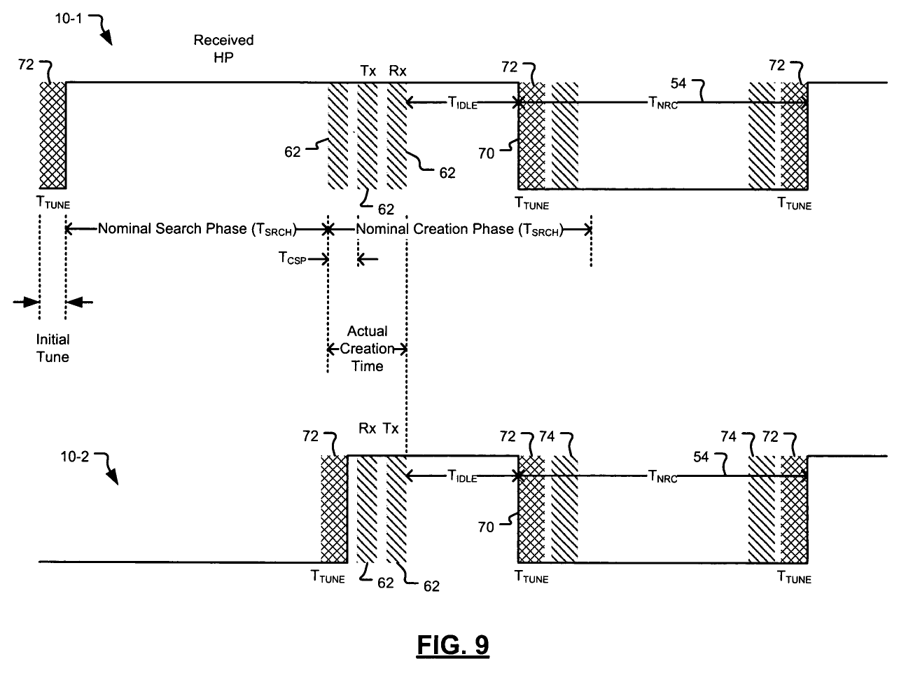

Referring now to FIG. 9, a timing diagram is shown of network creation between first wireless station 10-1 and second wireless station 10-2. First wireless station 10-1 executes an acquisition sequence by transmitting one or more HP IRC messages 62 at least once every network creation sub-period (T_{CSP}) for the search period T_{SRCH} or until HP IRC message 62 is received from station 10-2. Network creation timer 31 tracks T_{CSP}. The network will be created when one of the wireless stations 10-1, 10-2 receives HP IRC message 62 transmitted by the remaining one of wireless stations 10-1, 10-2 and adopts its timing at the end of T_{IDLE}. One of wireless stations 10-1, 10-2 repeats the acquisition sequence if it does not receive an HP IRC message 62 within a predetermined re-acquisition delay period T_{RA} which is tracked by reacquisition timer 29. T_{RA} should be greater than a high awareness (HA) timeout period T_{HA} that is described below.

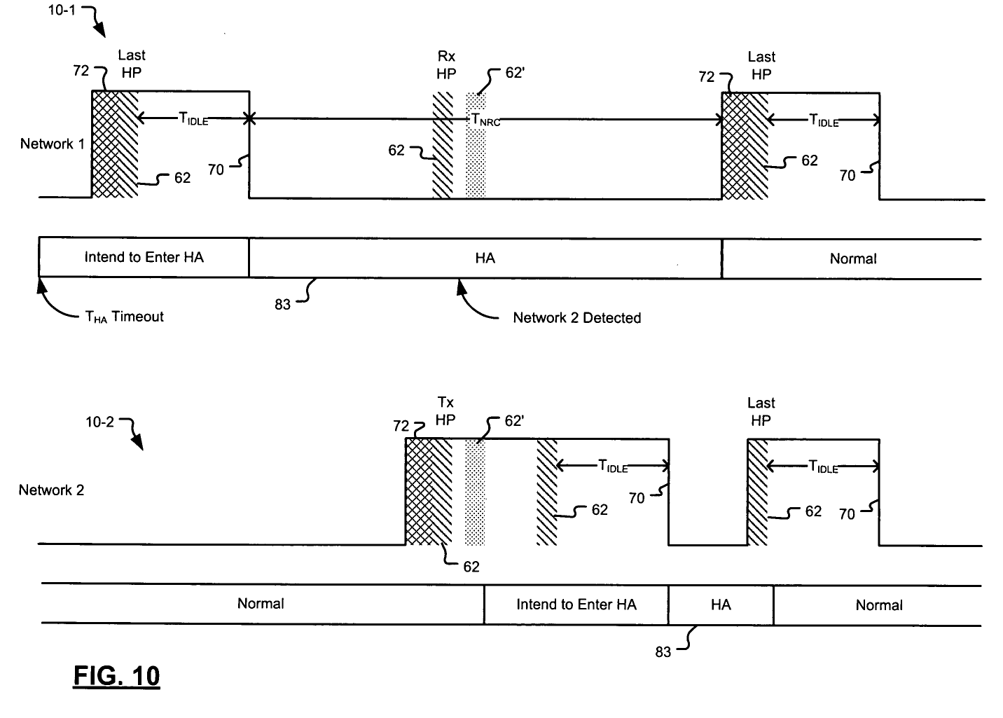

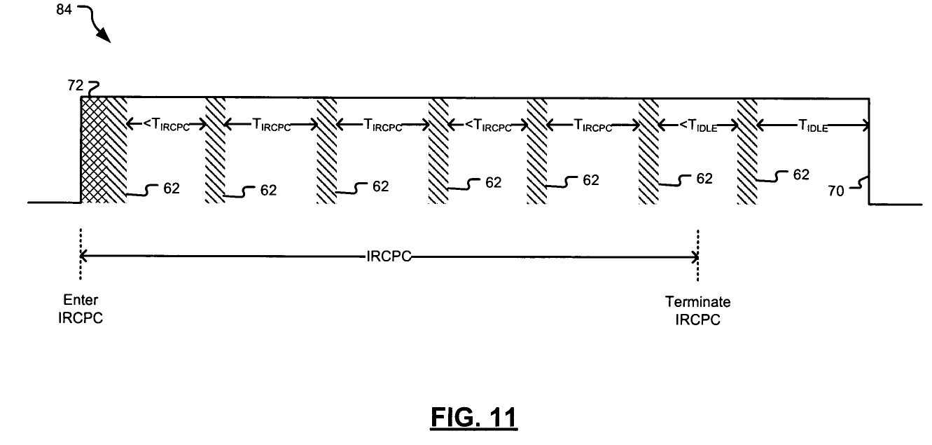

Referring now to FIG. 10 a timing diagram is shown of a first network that includes wireless station 10-1 joining a second network that includes station 10-2. Such an event occurs when the first and second networks are unsynchronized (i.e. have respective IRC periods that occur during different times) and converge upon one another. Such an event can also occur when the first and second networks were previously combined and recombine after becoming unsynchronized due to a third wireless station 10 (not shown), interference, blocking, or an interruption of service.

A high-awareness (HA) mode 83 is executed at a regular period and used to detect other networks. HA mode 83 is triggered after the HA timeout period T_{HA} expires. T_{HA} is tracked by HA timer 33 and restarts each time it expires. The respective HA timeout of each wireless station 10-1, 10-2 should be randomized, however T_{HA} should be fixed for a particle wireless station 10. In some embodiments T_{HA} may be determined dynamically. T_{HA} should not be set to a value less than T_{HA}+T_{NRC}. In some embodiments HA mode 83 can be triggered with increased frequency as wireless station 10-1 is tuned away from the IRC for increased percentages of NRC period 54. In some embodiments, first station 10-1 can also be designated to enter HA mode 83 more frequently than second station 10-2 and thereby facilitate synchronizing networks in a particular area.

First wireless station 10-1 executes HA mode 83 by remaining tuned to the IRC during NRC period 54 and listening for HP IRC messages 62 from second station 10-2. In some embodiments first wireless station 10-1 transmits an HA direction message 62′ that instructs other wireless stations 10 (not shown) to also enter HA mode 83. In general, if first wireless station 10-1 is in HA mode due to reaching its respective T_{HA} period and then receives HP IRC message 62, then first wireless station 10-1 transmits HA direction message 62′. If first wireless station 10-1 is in HA mode 83 due to receiving HA direction message 62′ from another wireless station 10 and then receives HP IRC message 62, then first wireless station 10-1 then it exits HA mode 83 and enters IRC period 52 instead of waiting for the expiration of HA mode 80. First wireless station 10-1 will thereby join and adopt the timing of the second network.

First wireless station 10-1 may also elect not to enter HA mode 83 upon receiving HA direction message 62′ if it entered HA mode 83 in an HA exception period T_{HAE}. The HA exception period can be initiated by a wireless station 10 that is within range of two networks that are not synchronized with each other. In such a situation the HA exception period prevents wireless station 10 from “ping-ponging” or repeatedly attempting to synchronize with each of the unsynchronized networks. T_{HAE} starts at the end of HA mode 83. The duration of T_{HAE} is predetermined and should be larger than T_{IDLE}+T_{NRC}+T_{RX} and less than T_{HA}/2

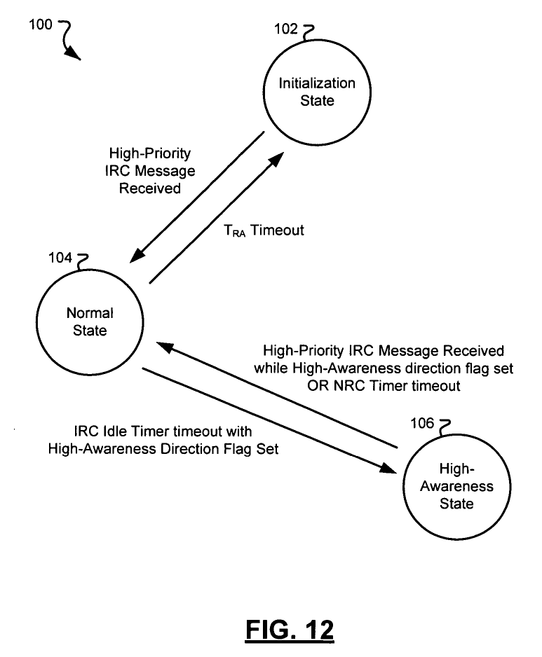

Referring now to FIG. 11 a timing diagram is shown of an IRC Point Coordination sequence (IRCPC) sequence 84 that is employed to extend IRC period 52. IRCPC 84 keeps networked wireless stations 10 tuned to the IRC and can thereby reduce IRC message latency as HP IRC messages 62 propagate through wireless stations 10. IRCPC 84 may be used to extend IRC period 52 so that the end of IRC period 52 is thereby influenced. Since the end of IRC period 52 may be influenced, the beginning of the next IRC period 52 can also be influenced. In this manner IRCPC 84 may be used to adjust the total combined period T_{C} of IRC period 52 and NRC period 54. IRC system access module 24 may also use IRCPC 84 to align transitions between IRC period 52 and NRC period 54, or vice-versa, to a desired time reference. IRCPC 84 can also be used to move or maintain those transitions so that IRC periods 52 and/or NRC periods 54 straddle a desired time reference.

IRC system upper layers 30 instruct IRC system access module 24 to execute IRCPC 84. If the IRC system access module 24 is not in IRC period 52 already then it immediately transitions to IRC period 52. In addition to normal IRC period 52 operations, IRC system access module 24 transmits HP IRC message 62 before IRC idle timer expires at T_{IDLE} and thereby resets IRC idle timer. If there is no HP IRC message 62 queued then IRC system access module 24 generates a dummy HP IRC message 62 to transmit upon expiration of an IRC Point Coordination Delay period T_{IRCPC}. IRC system upper layers 30 terminate IRCPC 84 by instructing IRC system access module 24 to stop generating HP IRC messages 62 simply for the purpose of continuing IRCPC 84. The current IRC period 52 then terminates upon expiration of the IRC idle timer 25.

Referring now to FIG. 12 a state diagram 100 is shown for wireless station 10 during IRC period 52. Control begins in an initialization state 102 and switches to a normal state 104 upon receiving HP IRC message 62. Control transitions from normal state 104 to HA state 106, which includes HA mode 83, upon receiving HA direction message 62′ (FIG. 10) and expiration of IRC idle timer 25. Control then returns to normal state 104 upon receiving HP IRC message 62 and/or expiration of NRC period 64. Control transitions from normal state 104 to initialization state 102 upon expiration of the re-acquisition delay period T_{RA}.

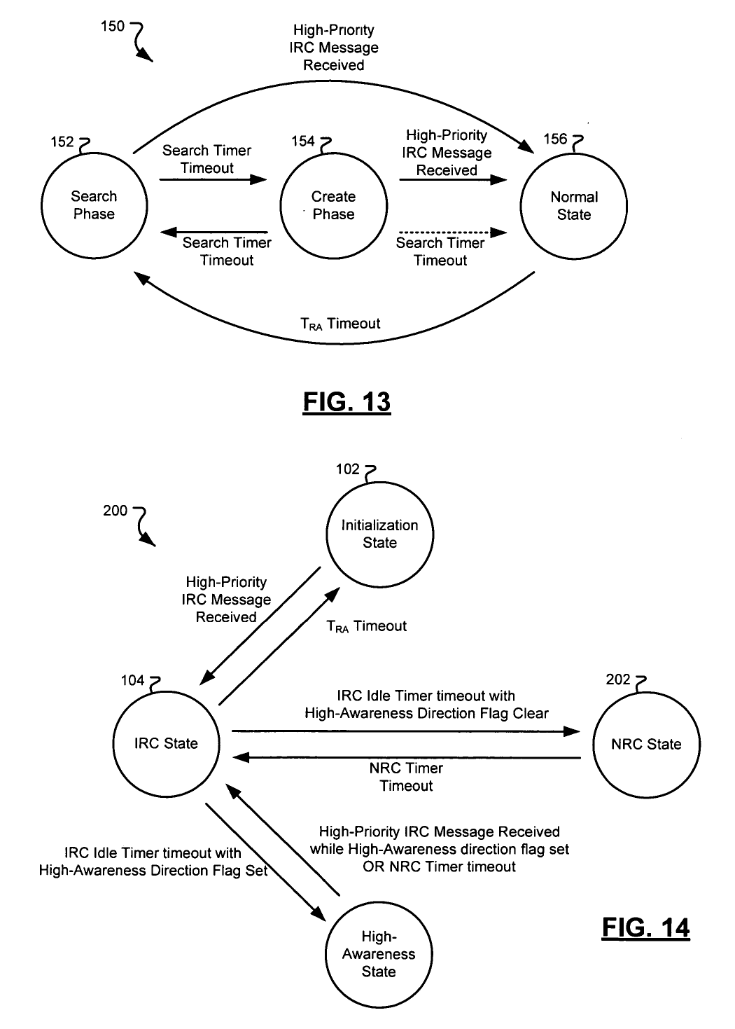

Referring now to FIG. 13 a state diagram 150 is shown of IRC system access module 24. Control begins in search phase 152 by initializing search timer 27 to T_{SRCH} and attempting to detect and join an existing network of wireless stations 10. Control proceeds from search phase 152 to create phase 154 upon expiration of the search period T_{SRCH}. In create phase 154 control transmits HP IRC messages 62 at the period T_{CSP} until HP IRC message 62 is received from another wireless station 10. Alternatively, control proceeds from search phase 152 to a normal state 156 upon receiving HP IRC message 62 from another wireless station 10 before the search period T_{SRCH} expires.

In normal state 156 control executes steps that include stopping search timer 27, initializing reacquisition timer 29, and reinitializing HA timer 33 to zero (to remain in HA mode 83) or a random number. Control proceeds from normal state 156 to search phase 152 upon expiration of the re-acquisition delay period T_{RA}.

Control proceeds from create phase 154 to normal state 156 upon receiving HP IRC message 62. In the event that no HP IRC message 62 is received prior to expiration of search period T_{SRCH} control may proceed to either search phase 112 or normal state 156 depending upon a selected embodiment.

Referring now to FIG. 14 a state diagram 200 is shown of IRC system access module 24 operating with NRC system access module(s) 26. State diagram 200 includes initialization state 102, IRC state 104, and HA state 106 which function as described in FIG. 12. Additionally, control proceeds from IRC state 104 to an NRC state 202 upon expiration of IRC idle timer 25 provided that control is not in HA mode 83. Control proceeds from NRC state 202 to IRC state 104 upon expiration of NRC period 54.

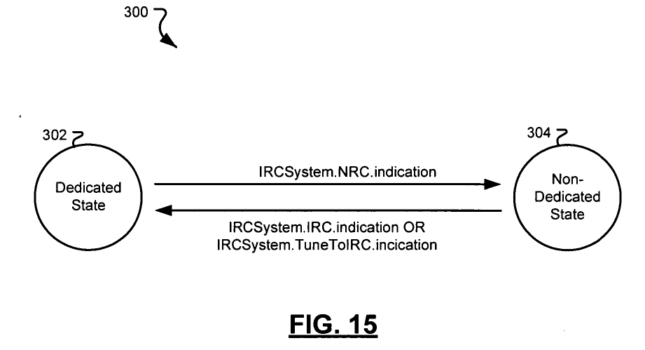

Referring now to FIG. 15 a state diagram 300 is shown of SME-CMM 22. Control begins in a dedicated state 302 and only listens to commands from IRC system access module 24. Control proceeds from dedicated state 302 to non-dedicated stated 304 upon receiving an indication from IRC system access module 24 that wireless station 10 may be tuned to the NRC(s). Control returns from non-dedicated state 304 to dedicated state 302 upon receiving an indication from IRC system access module that wireless station may only be tuned to the IRC.

Those skilled in the art can now appreciate from the foregoing description that the broad teachings of the present invention can be implemented in a variety of forms. Therefore, while this invention has been described in connection with particular examples thereof, the true scope of the invention should not be so limited since other modifications will become apparent to the skilled practitioner upon a study of the drawings, the specification and the following claims.

What is claimed is:

1. A wireless station for communicating digital messages, comprising:
a first transceiver tuned to a first radio frequency; and
a digital controller that enables the first transceiver to transmit on the first radio frequency during intermittent periods of varying durations that are separated by a fixed duration.

2. The wireless station of claim 1 further comprising:
a second transceiver tuned to a second radio frequency; and
a medium access controller (MAC) that communicates with the first transceiver, the second transceiver, and the digital controller, wherein the digital controller enables the second transceiver to transmit on the second radio frequency during the fixed duration.

3. The wireless station of claim 2 further comprising a multiplexer that communicates with the MAC and routes messages to one of a first computer application and a second computer application in accordance with a select signal from the digital controller.

4. The wireless station claim 3 wherein the first computer application is associated with the first transceiver and the second computer application is associated with the second transceiver.

5. The wireless station of claim 1 wherein each of the varying durations are based on a number of messages that the first transceiver sends and receives on the first radio frequency.

6. The wireless station of claim 1 wherein each of the intermittent periods terminates upon the first radio frequency being quiet for a predetermined period.

7. The wireless station of claim 1 wherein the first transceiver transmits on the first radio frequency during the fixed duration in response to receiving a message on the first radio frequency during the fixed duration.

8. A method for communicating digital messages over a wireless medium, comprising:
tuning to a first radio frequency; and
transmitting on the first radio frequency during intermittent periods of varying durations that are separated by a fixed duration.

9. The method of claim 8 further comprising:
tuning to a second radio frequency; and
transmitting on the second radio frequency during the fixed duration.

10. The method of claim 9 further comprising routing messages communicated over the first radio frequency to a first computer application and routing messages communicated over the second radio frequency to a second computer application.

11. The method of claim 8 wherein each of the varying durations are based on a time between messages communicated over the first radio frequency.

12. The method of claim 8 wherein each of the intermittent periods terminates upon the first radio frequency being quiet for a predetermined period after carrying a message.

13. The method of claim 8 further comprising transmitting a message on the first radio frequency during the fixed duration in response to receiving a message on the first radio frequency during the fixed duration.

14. A wireless station for communicating digital messages, comprising:
first transceiver means for communicating over a first radio frequency; and
digital controller means for enabling the first transceiver means to transmit on the first radio frequency during intermittent periods of varying durations that are separated by a fixed duration.

15. The wireless station of claim 14 further comprising:
second transceiver means for communicating over a second radio frequency; and
medium access controller (MAC) means for communicating with the first transceiver means, the second transceiver means, and the digital controller means and for enabling the second transceiver to transmit on the second radio frequency during the fixed duration.

16. The wireless station of claim 15 further comprising multiplexing means for communicating with the MAC means and routing messages to one of a first computer application and a second computer application in accordance with a select signal from the digital controller means.

17. The wireless station claim 16 wherein the first computer application is associated with the first transceiver means and the second computer application is associated with the second transceiver means.

18. The wireless station of claim 14 wherein each of the varying durations are based on a number of messages that the first transceiver means sends and receives over the first radio frequency.

19. The wireless station of claim 14 wherein each of the intermittent periods terminates upon the first radio frequency being quiet for a predetermined period.

20. The wireless station of claim 14 wherein the first transceiver menas transmits on the first radio frequency during the fixed duration in response to receiving a message over the first radio frequency during the fixed duration.
